(19) United States
(12) Patent Application Publication
(10) Pub. No.: US 2010/0248193 A1
(43) Pub. Date: Sep. 30, 2010

(54) Method of Dietary Management of a Diet-Responsive Disease or Condition

(76) Inventors: Scott Donald Whalen, Cincinnati, OH (US); Nathan Daniel Estruth, Cincinnati, OH (US); John Michael Jensen, Wyoming, OH (US); Chaz Adam Giles, Cincinnati, OH (US); Michael Bernard Dugas, Wyoming, OH (US); Tracie Vanessa Blenman, West Chester, OH (US); Sandeep Kumar Jandial, Loveland, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/729,309

(22) Filed: Mar. 23, 2010

Related U.S. Application Data
(60) Provisional application No. 61/163,914, filed on Mar. 27, 2009.
(60) Provisional application No. 61/163,922, filed on Mar. 27, 2009.
(60) Provisional application No. 61/163,925, filed on Mar. 27, 2009.

(51) Int. Cl. G09B 19/00

(52) U.S. Cl. 434/127

(57) ABSTRACT

Food products for the dietary management of a diet-responsive disease or condition, a method of dietary management of a diet-responsive disease or condition, and a system for providing such food products are disclosed. In one embodiment, the system involves (a) providing the name of at least one medical professional or medical professional's office or practice for consultation by participants and, if applicable, for writing orders for food products for participants; (b) providing controlled access to a supply of food products; and (c) providing the food products to the participants. The food products can be supplied in any suitable manner. Suitable manners of providing a supply of food products include, but are not limited to providing the food products at retail outlets, such as stores that have pharmacies, and drug stores, or through a website.

### CROSS REFERENCE TO RELATED APPLICATIONS

This application claims the benefit of U.S. Provisional Application Nos. 61/163,914; 61/163,922; and 61/163,925, all of which were filed on Mar. 27, 2009, which are incorporated by reference herein.

### FIELD OF THE INVENTION

The present invention is directed to food products for the dietary management of a diet-responsive disease or condition, methods of dietary management of a diet-responsive disease or condition, and systems for providing such food products.

### BACKGROUND OF THE INVENTION

Numerous diet products and programs have been developed for various purposes. ALLI™ is the reduced-strength version of orlistat (branded name XENICAL®), a prescription drug to treat obesity. It is approved for over-the-counter sale to overweight adults 18 years and older. ALLI™ is meant to be used in conjunction with a low-calorie, low-fat diet and regular exercise. Other diet products and programs include: GLUCERNA® nutritional products for people with diabetes (sold by Abbott Laboratories); Campbell Soup Company's INTELLIGENT QUISINE® program (see U.S. Pat. Nos. 5,639,471; 5,977,059; 5,994,295; 6,039,978; 6,039,989; 6,102,706; and 6,189,330 B1); NUTRISYSTEM® weight loss system; Physicians WEIGHT LOSS Centers® programs; STOUFFER′S® LEAN CUISINE® foods; and WEIGHT WATCHERS® weight loss program (see U.S. Pat. Nos. 4,652,241; 6,040,531; and 6,878,885 B2).

Several other diet products and programs are described in the patent literature. Nutritional compositions used in the treatment or prevention of metabolic syndrome, diabetes or obesity are described in U.S. Patent Application Publication US 2004/0087514 A1, published in the name of Hughes, et al. A method of using gamma cyclodextrin to control blood glucose and insulin secretion is described in U.S. Patent Application Publication US 2005/0215523 A1, published in the name of Lai, et al.

Some current dietary or nutritional programs involve the use of medical foods. “Medical foods” are defined by the U.S. Food and Drug Administration as a “food which is formulated to be consumed or administered enterally under the supervision of a physician and which is intended for the specific dietary management of a disease or condition for which distinctive nutritional requirements, based on recognized scientific principles, are established by medical evaluation.” Suppliers of medical foods include: Abbott Nutrition (www.abbottnutrition.com); Applied Nutrition Corp. (www.medicalfood.com); Metagenics (www.metagenics.com); Nationwide Medical Foods (www.medicalfoods.com); Nutricia North America (www.nutricia-na.com); and Primus Pharmaceuticals (www.limbrel.com). These medical foods are often provided in the form of meal replacement products, such as liquids, cereals, snack bars, meal bars, pills, and shakes, rather than in the form of actual food dishes as part of a meal.

Many diet programs rely on reducing serving portion size to reduce the intake of calories. This can leave the dieting individual feeling hungry. Other products and programs provide reduced calorie foods; however, often such foods are poor tasting. The search for improved diet foods and foods for dietary management of a diet-responsive disease or condition, and methods of dietary management of a diet-responsive disease or condition has, therefore, continued. In particular, it is desirable to provide diet foods and food products for dietary management of a diet-responsive disease or condition that have a good taste which are provided in substantial sized portions, but which have significant calorie and fat reduction compared to non-diet (i.e., full calorie) equivalent foods.

### SUMMARY OF THE INVENTION

The present invention is directed to food products for the dietary management of a diet-responsive disease or condition, methods of dietary management of a diet-responsive disease or condition, and systems for providing such food products. There are numerous non-limiting embodiments of the present invention.

In one non-limiting embodiment, food products for dietary management of a diet-responsive disease or condition are provided which contain a fat replacement ingredient. The food products may be in any suitable form including, but not limited to, in the form of, or as a component of a frozen or shelf stable: complete meal, main course of a meal, appetizer, entree, side dish for a meal, sauce, dressing, dessert, snack, cooked food, hot food, microwavable food, cooking oils, and spreads. The food products may be prepared using recipes which have been modified to replace at least some of the digestible fat with a fat replacement ingredient and then prepared for storage, distribution and consumption after a period of time beyond the normal life of the food (e.g., five, seven, or more days later). In some embodiments, the fat replacement ingredient comprises a partially digestible or non-digestible fat. In certain cases, the food products have less than or equal to about 30% of their calories comprised of fat.

A method of dietary management of a diet-responsive disease or condition is also provided. Such diet-responsive diseases or conditions can potentially include, but are not limited to: atherosclerotic disease, cardiovascular disease, coronary heart disease, diabetes, dyslipidemia, hypercholesterolemia, hypertension, metabolic syndrome, obesity, osteoarthritis, overweight, pre-diabetes, satiety, and sleep apnea. Managing life-style and diet may also lower one or more potential risk factors for certain types of cancer, such as breast, endometrium, colon, kidney, and esophageal cancers.

One non-limiting embodiment of the method of dietary management of a diet-responsive disease or condition comprises:
(a) providing at least one food item for dietary management of a diet-responsive disease or condition that is at least consumer-equivalent relative to a comparable diet food item, said food item being in a form selected from the group consisting of a frozen or shelf stable: complete meal, main course of a meal, appetizer, entree, side dish for a meal, sauce, dressing, dessert, snack, cooked food, hot food, microwavable food, cooking oil, and spread;
(b) informing at least one medical professional (or “prescriptor”) of the availability of said at least one food item if said medical professional is not aware of the same, and of the medical professional's (or prescriptor's) ability to supervise a consumer's (or patient's) use of said food item, and/or, if applicable, to write an order for said at least one food item;
(c) providing a consumer with a plan for reducing their daily caloric intake by an average amount greater than or equal to about 25, alternatively, greater than or equal to about 50, alternatively greater than or equal to about 100 calories per day when said consumer consumes at least one said food item per day; and
(d) allowing a consumer to purchase said at least one food item after said consumer is under medical supervision for use of said food item, and/or said medical professional writes an order, if applicable, for said at least one food item, wherein said consumer ingests a quantity of said food items over a period of time to change (that is, transform or be transformed) from having a first state of a diet-responsive disease or condition to a second state wherein said diet-responsive disease or condition is improved in said second state relative to said first state.

In another embodiment, a method of controlling caloric intake and/or amount of calories burned by a consumer (or participant) is disclosed. In one version of this embodiment, the method comprises: (a) providing a consumer with a program or plan for: (i) reducing their average daily caloric intake over a period of time by greater than or equal to about 25 calories, alternatively, greater than or equal to about 50, alternatively greater than or equal to about 100 calories; and (ii) increasing the participant's physical activity to use an additional 50 or more, or alternatively 100 or more calories per day; (b) providing a plurality of prepackaged food items to the consumer, each of the food items comprising an at least consumer-equivalent, reduced fat food product comprising a fat replacement ingredient, wherein said food product is packaged for storage and distribution, and is suitable for consumption five or more days after being packaged; and (c) the consumer ingests a sufficient quantity of said food products over a period of time to change (transform or be transformed) from having a first state of a diet-responsive disease or condition to a second state wherein said diet-responsive disease or condition in said second state is improved relative to said first state. In certain embodiments, the duration of the period of time over which the program is provided may be any number of months greater than one month, up to a year, or more. In certain embodiments, the method may provide diet and activity guidance in the form of one or more tips (that is, items of information or suggestions) to the participant.

In another embodiment, a system for providing food products is disclosed. One version of the system comprises: (a) informing at least one medical professional (or “prescriptor”) of the availability of at least one food product for dietary management of a diet-responsive disease or condition if said medical professional is not aware of the same, and of the medical professional's or prescriptor's ability to supervise a consumer's (or patient's) use of said food product, and/or, if applicable, to write an order for said at least one food product; (b) providing consumers with controlled access to a supply of food products, wherein the amount of at least one ingredient in the food product is tracked by a computer so a consumer can gain access to a food product that would not otherwise be available; and (c) providing the food products to the consumers. The food products can be supplied in any suitable manner. Suitable manners of providing a supply of food products include, but are not limited to providing the food products at retail outlets, such as stores that have pharmacies, and drug stores, or through an internet website. In one embodiment, a website is provided at which food products may be ordered by consumers, and (1) the website has controls so that only those consumers under medical supervision and/or with orders from a medical professional can order food products from the website and/or (2) the website has controls to control the amount of one or more ingredients that are provided to and/or consumed by a consumer over a period of time. In other embodiments, the website may comprise an invention in its own right. The food products may optionally be delivered to one or more consumers.

In other embodiments, the methods described herein may comprise fewer steps than those described above. Alternatively, the methods can comprise additional steps.

### BRIEF DESCRIPTION OF THE DRAWINGS

The following detailed description will be more fully understood in view of the drawings in which:

FIG. 1 is a flow chart which shows one embodiment of system for providing food products.

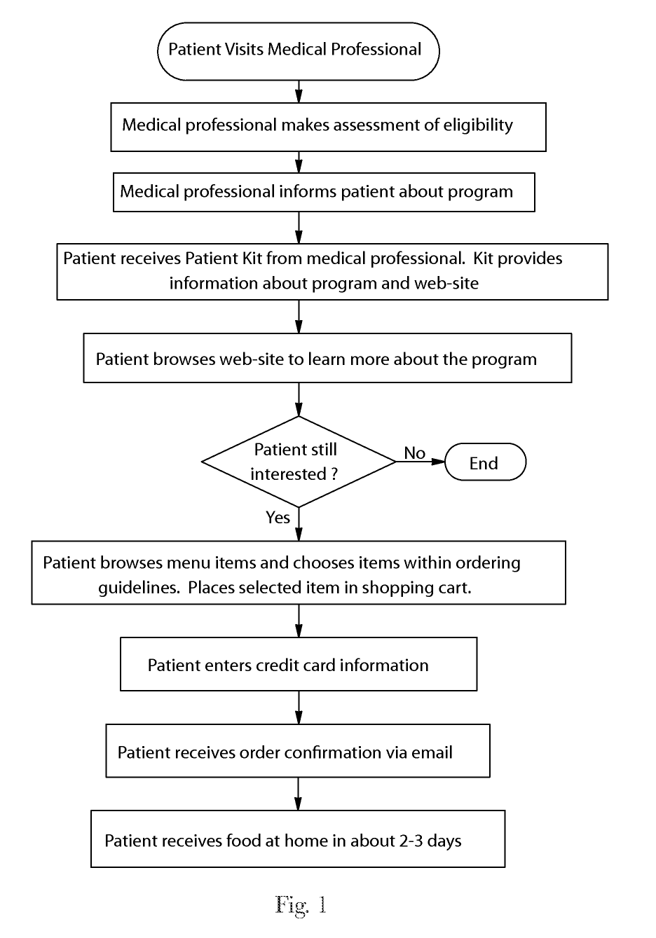

FIG. 2 is a graph which shows body fat loss over time for several diet programs.

The embodiment of the system shown in the drawings is illustrative in nature and is not intended to be limiting of the invention defined by the claims. Moreover, the features of the invention will be more fully apparent and understood in view of the detailed description.

### DETAILED DESCRIPTION

### I. Introduction

The present invention is directed to food products for the dietary management of a diet-responsive disease or condition, methods of dietary management of a diet-responsive disease or condition, and systems for providing such food products.

### DEFINITIONS

The term “consumer-equivalent”, as used herein, refers to foods that are judged by consumers to be equivalent to comparable diet food items according to the Test Method described herein.

The term “consumer preferred”, as used herein, refers to foods that are preferred by consumers over comparable diet food items according to the Test Method described herein.

The term “controlling”, as used herein, refers to the treatment, prevention, amelioration, control, delay of progression or dietary management of the diseases, symptoms, conditions and disorders described herein.

The term “cooked food”, as used herein, refers to food which is prepared, after opening any package containing the same, by exposing the food to some heat energy, such as: preparing on a stove top, heating in a microwave oven, or by baking in an oven. The term “cooked food”, as used herein, is distinguishable from cereals and snack bars that were only cooked prior to packaging and are not intended to be heated after the package is opened. It is also within the scope of the term “cooked food” for such cooked food to have also been partially or fully cooked and/or cured prior to packaging.

The term “entrée”, as used herein, refers to the principal or main dish of a meal.

The terms “food products or food items for the dietary management of a diet-responsive disease or condition”, as used herein, refer to food products with one or more of the fat replacement ingredients described herein that comprise: (a) foods for special dietary uses; (b) medical foods; and, (c) foods that are used to manage one or more of the following diet-responsive diseases or conditions: atherosclerotic disease, cardiovascular disease, coronary heart disease, type 2 diabetes and/or impaired glucose tolerance, dyslipidemia, hypercholesterolemia, hypertension, metabolic syndrome, obesity, osteoarthritis, overweight, pre-diabetes, satiety, and sleep apnea, or to reduce risk factors for one or more of: breast, endometrium, colon, kidney, and esophageal cancers. In some embodiments described herein, certain diseases or conditions may be specifically excluded from the foregoing list.

The term “foods for special dietary uses”, as used herein, refers to foods that meet the following definition of “special dietary uses” which is contained in Title 21, Section 105.3(a)(1) of the United States Code of Federal Regulations (CFR):
The term special dietary uses, as applied to food for man, means particular (as distinguished from general) uses of food, as follows:
   (i) Uses for supplying particular dietary needs which exist by reason of a physical, physiological, pathological or other condition, including but not limited to the conditions of diseases, convalescence, pregnancy, lactation, allergic hypersensitivity to food, underweight, and overweight;
   (ii) Uses for supplying particular dietary needs which exist by reason of age, including but not limited to the ages of infancy and childhood;
   (iii) Uses for supplementing or fortifying the ordinary or usual diet with any vitamin, mineral, or other dietary property. Any such particular use of a food is a special dietary use, regardless of whether such food also purports to be or is represented for general use.

The term “full calorie food”, as used herein, refers to a non-reduced calorie, or non-diet food.

The term “hot food”, as used herein, refers to foods that the consumer is instructed to heat before serving. The food will, thus, have a temperature above room temperature before serving.

The term “hypocaloric”, as used herein, refers to a food item that provides a reduction in calories in the range of 20-300 calories in comparison to the same food item which has been prepared with traditional fat ingredients.

The term “meal replacement products”, as used herein, refers to products such as drinks (e.g., drink mixes, packaged drinks, shakes, etc.) and edible bars that are intended to be consumed in the place of a meal.

A “medical food” in the United States is defined by the U.S. Food and Drug Administration (FDA) as a “food which is formulated to be consumed or administered enterally under the supervision of a physician and which is intended for the specific dietary management of a disease or condition for which distinctive nutritional requirements, based on recognized scientific principles, are established by medical evaluation.” The terms “medical food” and “medical food item” may be used interchangeably herein.

The terms “microwavable” or “microwavable food”, as used herein, refer to foods that the consumer is instructed to heat in a microwave oven before serving.

The terms “partially digestible fats” and “non-digestible fats”, as used herein, refer to fats yielding less than or equal to about 7 calories per gram of dietary energy (versus the approximate 9 calories per gram of dietary energy yielded from a traditional digested fat).

The term “prescriptor”, as used herein, refers to a medical professional or other individual who is authorized to write an order for medical foods or foods for special dietary uses, to the extent such an order is necessary.

The term “salted snacks”, as used herein, refers to foods such as potato chips, corn chips, tortilla chips, curls, puffs, potato sticks, French fries, and shoestring potatoes.

The term “shelf stable”, as used herein, refers to food products that can be distributed and sold without the need for refrigeration or frozen storage to prevent microbial spoilage.

The term “similar to traditional recipe”, as used herein, refers to foods that are found by consumers to have a taste that compares favorably to comparable traditional recipe food items according to the Test Method described herein.

The term “traditional recipe”, as used herein, refers to food that has not been altered to reduce the fat, calorie, sugar or other content of the food item.

### II. The Food Products

Food products for the dietary management of a diet-responsive disease or condition, as defined above, are provided herein. In some embodiments, the food products may fall into one or more, but not all, of the categories defined above of: (a) foods for special dietary uses; (b) medical foods; and (c) foods used to manage one or more of the enumerated diet-responsive diseases or conditions. The term “food products” described herein may be referred to alternatively herein as “food items”. The food products may be prepared using recipes which have been modified or transformed to replace at least some of the digestible fat with a fat replacement ingredient and then prepared for storage, distribution and consumption after a period of time beyond the normal shelf life of the food (e.g., five, seven, or more days later), using one of many preservation techniques.

The food products of interest herein comprise a fat replacement ingredient such as reduced calorie fat ingredients or compositions. The food products may have less than or equal to about 30% of their calories derived from fat. In some embodiments, the fat replacement ingredient comprises a partially digestible or non-digestible fat-like material alone, or in combination with other ingredients including, but not limited to certain reduced calorie triglycerides. For clarity, the 30% figure stated above does not include the fat replacement ingredient(s) described herein. Suitable partially digestible or non-digestible fat-like materials include, but are not limited to polyol fatty acid polyesters having at least 4 fatty acid ester groups, wherein said polyol is selected from the group consisting of sugars and sugar alcohols containing from 4 to 8 hydroxyl groups and wherein each fatty acid group has 2-24 carbon atoms. Sucrose polyesters (or “SPE's) are specific types of polyol fatty acid polyesters. These polyol fatty acid polyesters and SPE's are fat-like materials which are not absorbed by the body. They have taste and working characteristics similar to digestible fats and oils and may be substituted for them in many foods.

One form of a suitable SPE is OLESTRA™. OLESTRA™ is an SPE with a mixture of octa-, hepta-, and hexa-esters of sucrose with fatty acids derived from edible fats and oils or fatty acid sources that are generally recognized as safe or approved for use in certain foods. The chain lengths of the fatty acids are no less than 12 carbon atoms. OLESTRA™ has zero digestible calories. OLEAN® is the Procter & Gamble Company's (Cincinnati, Ohio, U.S.A.) marketed name for OLESTRA™. In certain embodiments, it may be desirable for the fat replacement ingredients to have between zero and any number less than 9 calories per gram of dietary energy. Reduced calorie fat compositions, partially-digestible and non-digestible fat-like materials, lipids, polyol fatty acid polyesters, SPE's, and OLESTRA™ are further described in: U.S. Pat. No. 3,600,186, Mattson, et al.; U.S. Pat. No. 4,005,195, Jandacek; U.S. Pat. No. 4,005,196, Jandacek, et al.; U.S. Pat. No. 4,919,964, Adams, et al.; U.S. Pat. No. 4,950,140, Pflaumer, et al.; U.S. Pat. No. 4,960,600, Kester, et al.; U.S. Pat. No. 5,021,256, Guffey, et al.; U.S. Pat. No. 5,085,884, Young, et al.; U.S. Pat. No. 5,095,008, Pflaumer, et al.; U.S. Pat. No. 5,158,796, Bernhardt, et al.; U.S. Pat. No. 5,194,281, Johnston, et al.; U.S. Pat. No. 5,306,514, Letton, et al.; U.S. Pat. No. 5,306,515, Letton, et al.; U.S. Pat. No. 5,306,516, Letton, et al.; U.S. Pat. No. 5,314,707, Kester, et al.; U.S. Pat. No. 5,318,790, Houston, et al.; U.S. Pat. No. 5,419,925, Seiden, et al.; U.S. Pat. No. 5,422,131, Elsen, et al.; U.S. Pat. No. 5,534,284, Corrigan, et al.; U.S. Pat. No. 6,077,556, Letton, et al.; U.S. Pat. No. 6,261,628 B1, Howie; U.S. Pat. No. 6,821,545 B2, Bernhardt, et al.; U.S. Pat. No. 7,304,153 B1, Appleby, et al.; and U.S. Pat. No. 7,241,468, Naber, et al.

The fat replacement ingredient may be provided in any suitable form. For use in preparing the food products described herein, if an SPE is used, the SPE can be provided in any suitable form, including as is, or in the form of a blend. There are at least two types of blends of OLESTRA™ that are of interest herein. These include: 1) a blend of OLESTRA™ and an Intermediate Melting Fraction (or “IMF” triglyceride), which is a sucrose polyester (SPE) that has been hydrogenated, and 2) a blend of OLESTRA™ with triglycerides (such as a blend of soybean oil, OLESTRA™, and cottonseed oil). Intermediate Melting Fraction triglycerides are further described in U.S. Pat. No. 5,306,516, Letton, et al. The blends of OLESTRA™ and IMF may be referred to in any suitable manner, such as by designations such as “Blend 40”, “Blend 75”, or “Blend 100” with the number denoting the percentage of OLESTRA™ in the blend with the balance being the percentage of IMF. The blends of OLESTRA™ and triglycerides may also be referred to in any suitable manner, such as by designations such as a 75/25 blend, which would comprise 75% OLESTRA™ and 25% triglyceride. All percentages given throughout this specification are by weight, unless otherwise indicated. A number of the aforementioned blends are commercially available from The Procter & Gamble Company of Cincinnati, Ohio, U.S.A. The composition of several blends of interest is summarized in Table 1 below.

TABLE 1
OLESTRA ® Blends

| | Blend | % | | |
|---|---|---|---|---|
| Name of Blend | Number | OLESTRA ™ | IMF | Triglycerides |
| OLEAN ® | Blend 40 | 40% | 60% | — |
| DAIRY LEAN ™ | | | | |
| H | | | | |
| OLEAN ® | Blend 75 | 75% | 25% | — |
| DAIRYLEAN ™ P | | | | |
| OLEAN ® | Blend 100 | 100% | — | — |
| SOYBEAN ™ | | | | |
| OLEAN ® | Blend 75/25 | 75% | — | 25% |
| BAKELEAN ™ 75 | | | | |

In other embodiments, the fat replacement ingredient may comprise medium chain triglycerides (“MCT's”) (6-10 carbon length). These are not typically stored in body fat as they can be directly passed through the lumen of the intestine into the portal vein. This results in MCT's being more readily available for conversion to energy for use by the body and not accumulated in the fat storage compartments of the body. MCT's also require about 10% fewer calories to digest than long chain triglycerides LCT due to their smaller molecular weight and shorter carbon chains. Common natural sources of MCT are coconut and palm kernel oil.

The relative proportion of the fat replacement ingredient in the food products will, of course, vary considerably depending on the particular type of food product concerned. The food products may, for example, contain between about 0.1% to about 33% by weight, e.g. from about 0.5% to about 30% by weight, e.g. from about 0.5% to about 20% by weight of the fat replacement ingredient, based on the total weight of the food product. The fat replacement ingredient can be substituted for at least some of the fats or oils that would be needed in a particular recipe or formula, and conventional ingredients can be used for the balance of the recipe. All indicated proportions and relative weight ranges described herein are accordingly to be understood as being indicative of preferred and not limiting the invention.

In addition to replacing fat with a fat replacement ingredient, the food products may have reduced carbohydrates provided by carbohydrate replacement ingredients. The food products may also comprise artificial sweeteners, or other sugar substitutes. Such products may be of interest for diabetic or pre-diabetic consumers.

Conventional additives may be included in the food products, including any of those selected from: preservatives, chelating agents, osmotic agents, buffers or agents for pH adjustment, effervescing agents, salts, sweeteners, e.g. artificial sweeteners, flavoring agents, coloring agents, taste masking agents, acidulants, emulsifiers, stabilizers, thickening agents, suspending agents, dispersing or wetting agents, antioxidants, texturizers, antifoam agents, and the like.

The food products may be in any suitable form, e.g. in form of a complete meal, or part of a meal, including, but not limited to, in the form of, or as a component of a frozen or shelf stable: complete meal, main course of a meal, appetizer, entree, a side dish for a meal, sauce, dressing, dessert, snack, and may include cooked foods, hot foods, microwavable foods, cooking oils, and spreads. In some embodiments, certain types of foods may be excluded from the types of foods of interest herein. For instance, in some embodiments, the food products of interest may exclude one or more of the following: meal replacement products, salted snacks, salad dressings, including oils, and certain other food items including one or more food items described in the patents incorporated by reference herein. In certain embodiments, it may be desirable for the food products to be either frozen, shelf stable, or to be of a type that would not typically require refrigeration.

There are a number of processes that can be used for food preservation to transform the food products into a shelf stable form. These include, but are not limited to: heating to kill or denature organisms (e.g. boiling, pasteurization); sterilization; oxidation; smoking; vacuum sealing and modification of packaging atmosphere; canning, pH modification (e.g. acidification, lactic fermentation); dehydration (drying); osmotic inhibition (e.g. use of syrups); low temperature inactivation (e.g. freezing, refrigeration); ultra high water pressure; pulsed electric field; and irradiation. These processes can be used by themselves or in any suitable combination (e.g., freeze drying) to manage microbial growth to effect food preservation. These processes can also be used with a variety of storage processes which include, but are not limited to canning, retort packaging, freezing; and packing to prevent contamination.

The food products may be nutritionally complete. That is, they may include naturally present or added, antioxidants, carotenoids, vitamins, minerals, trace elements as well as nitrogen, carbohydrate and fatty acid sources; or, the consumer may obtain additional dietary fortification from other sources, such as vitamins and/or minerals, which may, for example, be obtained in the form of a multivitamin.

If embodiments of the food products described herein are optionally fortified with vitamins, the vitamins may comprise fat-soluble vitamins, including vitamin A, vitamin D, vitamin E, and vitamin K. The amount of fat-soluble vitamins employed herein to fortify the food products can vary. If desired, the food products can be fortified with a recommended daily allowance (RDA), or increment or multiple of an RDA, of any of the fat-soluble vitamins or combinations thereof. Vitamins that are nonsoluble in fat can similarly be included in the food products. These include, but are not limited to vitamin B complex vitamins, vitamin C, and other micronutrients. The minerals include the wide variety of minerals known to be useful in the diet, such as calcium, magnesium, and zinc. Any combination of vitamins and minerals can be used in the food products.

In certain embodiments, it may be desirable for the food products to comply with the American Heart Association nutritional guidelines. These include: 3 g fat or less, 1 g saturated fat or less, 20 mg cholesterol or less, 480 mg sodium or less, 10% or more of nutrients A, C, iron, calcium, protein, or fiber.

### III. Methods for Weight Management, and Treatment of Other Diet-Responsive Diseases and Conditions

Methods of dietary management of diet-responsive diseases and conditions are also provided herein. These diseases and conditions may include, but are not limited to: atherosclerotic disease, cardiovascular disease, coronary heart disease, type 2 diabetes and/or impaired glucose tolerance, dyslipidemia, hypercholesterolemia, hypertension, metabolic syndrome, obesity, osteoarthritis, overweight, pre-diabetes, satiety, and sleep apnea. Managing life-style and diet may also lower one or more potential risk factors for certain types of cancer, such as breast, endometrium, colon, kidney, and esophageal cancers.

The method of dietary management is applicable to normal weight, overweight, and obese subjects. The term “overweight subjects” as used herein refers to subjects with a Body Mass Index (BMI) of 25 to 29.9 kg/m², implying an excess amount of body weight that includes muscle, bone, fat, and water, in particular an excess amount of fat. The term “obese subjects” as used herein refers to subjects with a BMI of 30 kg/m² or higher and an excess amount of body fat, or a BMI of 27 kg/m² with comorbidities. The term “comorbidities”, as used herein, refers to the presence of one or more disorders (or diseases) in addition to a primary disease or disorder; or the effect of such additional disorders or diseases. It is generally agreed that men with more than 25% body fat and women with more than 30% body fat are obese.

In one embodiment, the method may comprise a step of providing one or more at least consumer-equivalent food item in a form selected from the group consisting of a frozen or shelf stable: complete meal, main course of a meal, appetizer, entree, a side dish for a meal, sauce, dressing, dessert, snack, cooked foods, hot foods, microwavable foods, cooking oils, and spreads. The food items may be full flavored. The method may comprise a step of informing at least one medical professional (or prescriptor) of the availability of at least one food item if the medical professional (or prescriptor) is not aware of the same. The medical professional or prescriptor can also be informed of their ability to supervise a consumer's (or patient's) use of the food item, and/or, if applicable, to provide approval (e.g., write an order) for at least one food item. Alternatively, or additionally, the step may comprise informing consumers of at least one medical professional who, if necessary, can write an order for the food item. The method may also include a step of providing a consumer with plan for reducing their daily caloric intake by an average amount greater than or equal to about 25 calories, alternatively, greater than or equal to about 50, alternatively greater than or equal to about 100 calories per day when the consumer consumes at least one food item. The method may further include a step of allowing a consumer to purchase at least one food item after the consumer is under medical supervision for use of the food item, and/or a medical professional writes an order, if applicable, for the food item. When carrying out the method, the consumer ingests a sufficient quantity of food items over a period of time to change (that is, transform or be transformed) from having a first state of a diet-responsive condition to a second state wherein the diet-responsive condition is improved in the second state relative to the first state. In certain versions of this method, the method may comprise a step of requiring a consumer to contact a medical professional prior to allowing a consumer to purchase the at least one food item. The food products may be consumed any suitable number of times over any suitable interval including, but not limited to once daily to e.g. five or more times daily.

In another embodiment, a method of controlling caloric intake and/or amount of calories burned is disclosed. In one version of this embodiment, the method comprises: (a) providing a consumer (or participant) with a program or plan for: (i) reducing their average daily caloric intake over a period of time by greater than or equal to about 25 calories, alternatively, greater than or equal to about 50, alternatively greater than or equal to about 100 calories; and (ii) increasing their physical activity to use an additional 50 or more, or alternatively 100 or more calories per day; (b) providing the consumer with a plurality of prepackaged food items (individually packaged, or containing more than one food item per package), each of the food items comprising an at least consumer-equivalent, reduced fat food product comprising a fat replacement ingredient, wherein the food is packaged for storage and distribution, and is suitable for consumption five or more days after being packaged; and the consumer ingests a sufficient quantity of the food items over a period of time to change from having a first state of a diet-responsive condition to a second state wherein the diet-responsive condition is improved in the second state relative to the first state.

In certain embodiments, the method may provide diet and/or activity guidance in the form of one or more tips (that is, items of information or suggestions) to the participant. Such tips include, but are not limited to: (1) when shopping, park further away from the store entrance; (2) when taking a bus, get off the bus early and walk to the last stop or two; (3) when cooking, use pureed fruit or applesauce as syrup; (4) add fresh fruit to plain low-fat yogurt instead of having fruit-flavored yogurt; and (5) take a walk after dinner instead of watching television. In certain embodiments, the period of time for the change in the diet-responsive condition may be any number of months greater than one month (e.g., six months, nine months, etc.), up or up to a year, or more. The diet-responsive condition can be the person's weight, or any of the other diet-responsive conditions described herein.

Without wishing to be bound by any particular theory, it is believed that weight loss and weight loss maintenance programs will be more successful (i.e., participants will lose weight and keep it off) if the program facilitates long-term compliance to a hypocaloric diet (through pharmaceutical means, or through more satisfying low-calorie foods) and/or incorporating activity to burn additional calories when the participant can no longer completely comply with a low-calorie diet. Such programs are also believed to be more successful if they provide a plan that provides a meal experience where the stomach satiation, and actual eating experience is more like a full calorie meal/plan. As used herein, a “relatively moderate reduction in daily caloric intake” refers to an average reduction of daily caloric intake of between about 25 and 1,000 calories per day, alternatively between about 50 and 500 calories per day, alternatively greater than or equal to about 100 calories per day. However, it should be understood that the individual foods described herein may provide a reduction in calories of between about 1 and 1,000, or more, calories in comparison to their full calorie equivalent. It is believed that if a person is able to reduce their daily caloric intake by an average of about 100 calories per day, or alternatively to increase their physical activity to use an additional 100 calories per day, they may be able to lose about 10 lbs. (4.5 Kg.) per year.

It is also believed that weight loss and weight loss maintenance programs will be more successful if they are combined with a physician-supervised program. The weight loss and weight loss maintenance program may also comprise a bundle of offerings comprising recommended foods, and personalized wellness services including one or more of the following: nutritional counseling, incorporating additional physical activity into a participant's lifestyle, physical fitness training, and behavior modification coaching (including positive visualizations) that integrates into a participant's life to provide for sustained weight loss and improved health. The program may provide for regular interaction with one or more advisors during the program. This may include regular (e.g., weekly, bi-weekly, monthly, quarterly, or semi-annual) visits to the participant's medical professional, or other counselor. With respect to physical activity, the participant can, for example, be instructed to engage in exercise for 30 minutes per day three to five days a week. The exercise would ideally be continuous for at least 30 minutes, but can also be in separate periods of exercise activity that total 30 minutes per day.

### IV. System for Providing the Food Products

A system, method, or program for providing the food products is also included herein. The system may comprise a step (a) of informing at least one medical professional (or prescriptor) of the availability of at least one food product for the dietary management of a diet-responsive disease or condition, particularly if the medical professional is not aware of the same. This step may also include informing the medical professional of the medical professional's (or prescriptor's) ability to supervise a consumer's (or patient's) use of the food product, and/or, if applicable, to write an order for the food product. Alternatively, or additionally, the system may comprise a step of providing the name of at least one medical professional or practice (or prescriptor's office or practice) for consultation by participants (patients or consumers) and, if applicable, for writing orders for food products for participants. The system may comprise a step (b) of providing participants with controlled access to a supply of food products, wherein the amount of at least one ingredient in the food product is tracked by a computer so a participant can gain access to food products that would not otherwise be available; and a step (c) of providing the food products to the participant.

The medical professional can be informed of the system or program in any suitable manner. The medical professional can be informed of the system or program directly by the manufacturer, or indirectly such as by providing website access, or through a medical colleague. It should be understood that whenever the terms “website”, “internet”, “e-mail”, and “database” are used herein, these sites or items may be accessed using a computer such as a general purpose digital computer, wireless handheld devices, or other devices. Additional ways of directly informing the medical professional of the system or program include mailings of literature and/or samples or offer of samples, in-person detailing visits to the medical professional, prescriptor or their employees, journal ads or articles, television, ads, symposia/convention information booths, speeches, sponsorships, etc.

The at least one medical professional may comprise a network of medical professionals or prescriptors. The network of medical professionals or prescriptors can comprise any suitable number of medical professionals greater than or equal to one. The medical professionals in the network can comprise any suitable type or types of medical professionals including, but not limited to: physicians, including primary care physicians and specialists, nurse practitioners, and pharmacists. The medical professionals may include those who have an existing medical practice, a group of medical professionals assembled for the purpose of carrying out the system described herein, or combinations thereof. If the U.S. FDA or other regulatory guidelines change so that individuals with other backgrounds (such as those delegated or authorized by medical professionals) are permitted to supervise the use of the food products described herein, and, if required, to write an order for the same, then such individuals will also be included within the scope of the term “medical professional”, as used herein.

Eligibility requirements may be established for participants to be a food product recipient. These eligibility requirements may be linked to a particular diet responsive condition. In one non-limiting embodiment, the eligibility requirement may be that the participant is overweight. Each medical professional may identify one or more patients that meet the eligibility requirements to be a food product recipient. The medical professional may also either serve to supervise the participant throughout the participant's enrollment in the program, or refer the participant to another medical professional who can serve to supervise the participant during the program.

A participant may learn about the program in any suitable manner, including during a routine office visit or through marketing materials (such as through a brochure mailed to their home, media advertising such as print, television, internet, mobile network, radio) which may be directed to the prospective participants, or provided under the sponsorship of the physician, by word of mouth, or other means.

It may be desirable for the prospective participant to have an initial consultation with a medical professional, and/or with others (such as representatives designated by the program sponsor). The initial consultation may take place in person, such as an office consultation, or via other communication means which can be live (e.g., a phone call), or serial via a digitally stored and transmitted conversation (e.g., email, workspace, instant message). During the consultation, a prospective participant will be informed about the program and provided with information about the program (which may include a brochure or a website or phone bank referral).

The participant may optionally be provided with a participant code or unique identifier (e.g., identification number, password, or the like) during the initial consultation, or the participant code may be provided by a customer service provider. The participant code may be logged into a database by the medical professional's practice, or by others, and used to identify and validate the participant during the remaining portions of enrollment or the program, such as for the food ordering process. The unique identifier (or identifier) can be the participant's telephone number, chart number, or other unique personal identifier, or a unique code assigned for this purpose.

The food products can be made by any suitable manufacturer and branded in any suitable manner. The food products can, for instance, be made by the same company that will sell the food products, or they can be made by one or more contract manufacturers on behalf of the company that will brand and sell the food products. The food products can be marketed under a trusted and/or trademarked/service marked name which may be a medicinal brand, a diet food brand, a full fat food brand, or the brand of a consumer-known company. Any such contract manufacturers may, if desired, also distribute the food, for instance under the brand of the brand owner or service owner. In addition, a holistic business platform can be provided which enables multiple companies to provide food products leveraging their brand names. The holistic platform can include: order entry/verification; product specifications for foods that will meet the applicable food requirements; and, up-to-date tracking and reporting, if necessary, to comply with food regulations, etc.

The food products can be supplied in any suitable manner. Suitable manners of providing a supply of food products include, but are not limited to providing the food products at retail outlets, such as stores that have pharmacies, in-store medical clinics, and drug stores; or, through a website.

Any or all of the food products may be selected by the participant, although in some embodiments, one or more food items may be pre-selected for the participants. In one embodiment, a website is provided at which food products may be ordered by participants, and the website may have controls so that only those participants under the supervision of a medical professional, and/or with orders from a medical professional can order food products from the website. The website may also be linked to a database that may track the amount of food products ordered by each participant. The website may have controls to control the amount of one or more ingredients are consumed by a participant over a period of time. In other embodiments, the website may comprise an invention in its own right. The website may be provided with menu planning, grocery lists, and recipes, among other things, to assist the participants. The database may also include or be linked to shopper loyalty databases and/or credit card databases. The food products may optionally be delivered to one or more participants for consumption in place of their usual foods.

The website may or may not be password protected. In one embodiment, the website is not password protected so that anyone may visit the site and see the food offerings. However, to begin ordering food, the program may require that a participant enter their unique ID number which may be verified or rejected based on matching information entered by the participant. The ID number validates that the participant has been qualified by their physician, meets the admission criteria, and enables placement of food orders.

It may be desirable to provide controlled access to the supply of food products. The amount of food a participant may order in a given period of time may be based on the daily intake limits established for the particular food products. For example, the website may limit the purchase of food (OLESTRA™) to a daily average of 10 grams per day on a rolling basis. The consumer may, for example, start with 300 grams of OLESTRA™ in their account, and for each day that passes after the order date, the consumer may accrue ten grams to replace the ten they are assumed to have eaten. The accrued amount plus the balance available in the consumer's account can be set so that it never exceeds a certain amount (e.g., 300 grams). This will ensure compliance with a 10.4 grams/day mean intake limit established (300 g/30 d=10 g/day) while providing consumers the flexibility to have an ample supply of food on hand. In addition to this purchase control system, consumers may be instructed to enjoy, or otherwise consume, a certain number (e.g., 1, 2, 3, etc.) of food items per day as guidance to help them manage their consumption of the order period.

Participants may use the website to order all or part of their food products for home delivery. Foods that are frozen may be shipped using dry ice or refrigerated transportation. Refrigerated transportation may be at any of the following temperatures: above (e.g., slightly above), at, or below freezing temperatures.

The program described above allows medical professionals to supervise the patients (or participants) and, if necessary, to write an order for the food products for eligible participants. The participant may then initiate the order via the website setting in motion the validation process and fulfillment and delivery of the food product to their home, which may occur, for example, in about 2-3 days. Additionally, the program may provide a participant with the ability to obtain supplemental support from one or more support providers to assist them on their weight management (or other condition management) journey. The one or more support providers can comprise a professional services team, or separate support providers. The support providers may include, but are not limited to: a medical professional, a registered dietician, a personal trainer, and a life coach. Such supplemental support can be delivered live during an in-person visit, such as at an office or the participant's home, or via the internet, instant message, phone, digital or digital serial communication.

The participant can purchase the food products in any suitable manner, such as with a credit card or a debit card over the telephone, internet, etc.; with an order or debit against a prepaid account, by paying directly to a retailer, manufacturer, or medical professional, etc.

The program described herein may also have a feature of providing the participant with a log or journal. The log or journal may include a table for the participant to record any suitable information including, but not limited to: the items consumed on a daily basis, the amount of each item consumed (e.g., number of servings), the number of calories in each item, and the amount of fat (e.g., grams of fat) in each item, and totals for the same. The log or journal may contain any other suitable information including, but not limited to: a space for recording the method by which they reduced their daily caloric intake and/or increased the number of calories they burned; tips for reducing the participant's caloric intake and/or for increasing the number of calories they burn; and motivational and/or positive reinforcement statements. The log or journal can be in physical form (e.g., paper or electronic paper with appropriate stylus or writing instrument, or it can be in digital form, such as in the form of software where the resulting document or database resides on a local PC, or a LAN or web-accessed server).

### EXAMPLES

Tables 2-5 contain non-limiting examples of the food products described herein. Table 6 describes the properties of these food products and Table 7 compares certain of these properties to comparable full calorie food items.

TABLE 2
GENERAL TSO'S CHICKEN
Serving = 274 gm

| Component/Ingredient | Wt. (gm) | % in Formula |
|---|---|---|
| Sauce | 64.00 | 18.82% |
| Broccoli Florets, IQF | 85 | |
| (Individually Quick Frozen) | | |
| Chicken, Breaded/Battered IQF | 125.43 | 34.90% |
| TOTALS | 274.43 | 100.00% |

Sauce:

| | | |
|---|---|---|
| Water | 27.51 | 42.99% |
| Soy Sauce, light | 7.46 | 11.66% |
| Brown Sugar, dark | 6.39 | 9.99% |
| Corn Syrup | 5.11 | 7.99% |
| Sherry Wine, salted | 3.20 | 5.00% |
| Chili Garlic Sauce | 5.37 | 8.39% |
| Sugar, granulated | 2.56 | 4.00% |
| Modified Corn Starch | 2.30 | 3.60% |
| Garlic Puree | 1.92 | 3.00% |
| Sesame Oil | 0.64 | 1.00% |
| Rice Vinegar | 0.64 | 1.00% |
| Ginger Puree | 0.48 | 0.75% |
| Yeast Extract | 0.26 | 0.40% |
| Xanthan Gum | 0.06 | 0.10% |
| Caramel Color | 0.06 | 0.10% |
| White Pepper, ground 60 | 0.03 | 0.05% |
| TOTALS | 64.00 | 100.00% |

Breaded/Battered Chicken:

| | | |
|---|---|---|
| Chicken Breast Meat, raw | 101.45 | 80.88% |
| Batter | 18.45 | 14.71% |
| Predust | 5.53 | 4.41% |
| TOTALS | 125.43 | 100.00% |

Batter:

| | | |
|---|---|---|
| Water | 12.30 | 66.67% |
| Batter/Breader | 6.15 | 33.33% |
| TOTALS | 18.45 | 100.00% |

### Batter Preparation:

1. Combine water and batter. Mix until smooth.

### Chicken Preparation:

1. Toss chicken in predust
2. Coat chicken with batter.
3. Fry chicken in OLEAN® DAIRY LEAN™ at 400° F. for 1 minute.
4. Bake chicken at 350° F. convection oven for 8-10 minutes (internal temperature at 170° F.).

### Sauce Preparation:

1. Pre-blend dry ingredients.
2. Combine remaining ingredients add pre-blend. Mix well.

### 3. Bring up to 190° F.

4. Cool and bring to 100% (add water to return sauce to 100% of desired weight)

### Preparation of General Tso's Chicken and Freezing Instructions:

1. Place breaded chicken and broccoli on tray.
2. Pour sauce over chicken.
3. Seal and freeze.

TABLE 3
CREAMY BALSAMIC VINAIGRETTE SALAD DRESSING
Serving = 3 gm

| | | % in |
|---|---|---|
| Component/Ingredient | Wt. (gm) | Formula |
| Water | 8.41 | 28.02% |
| Balsamic Vinegar | 7.69 | 25.63% |
| OLESTRA ™ -- OLEAN ® Soybean ™ | 5.71 | 19.02% |
| Extra Virgin Olive Oil | 2.70 | 9.01% |
| Canola Oil | 3.00 | 10.01% |
| Sugar | 1.32 | 4.41% |
| Salt | 0.65 | 2.16% |
| Caramel Color | 0.07 | 0.24% |
| Garlic Powder | 0.28 | 0.92% |
| Xanthan gum & Modified Gum Acacia | 0.12 | 0.41% |
| Black Pepper, ground 30 | 0.05 | 0.16% |
| TOTALS | 30.00 | 100.00% |

### Dressing Preparation:

1. Pre-blend gum with water under high shear.
2. Blend in remaining dry ingredients and vinegar.
3. Add oil and OLESTRA™ in a thin stream.
4. Blend until thoroughly emulsified.

TABLE 4
BUTTER POPCORN
Serving = 30 gm

| Component/Ingredient | Wt. (gm) | % in Formula |
|---|---|---|
| Popcorn | 24.73 | 86.39% |
| OLESTRA ™ - OLEAN ® SOYBEAN ™ | 2.88 | 10.08% |
| Salt, flour | 1.79 | 1.73% |
| Butter Flavor | 0.58 | 1.73% |
| Annatto Color | 0.02 | 0.07% |
| TOTALS | 30.00 | 100.00% |

### Popcorn and Bag Preparation:

1. Place all wet ingredients (OLEAN® & annatto color) into a 4,000 ml beaker.
2. Place a stir bar into beaker and place beaker on top of a heating & stirring plate
3. Turn on heat to ⅓ high and stir until OLEAN® is completely melted (140°-150° F.).
4. Turn off heat. Sieve dry ingredients (salt and flavor) into beaker.
5. Continue stirring until OLEAN® slurry cools to 100° F. +/−10° F.
6. Weigh popcorn kernels into bowl.
7. Weigh hot slurry over popcorn kernels. Mix well using spatula.
8. Weigh 30 g coated popcorn kernels into popcorn bag, placing in middle third of bag
9. Seal bag using hand sealer.
10. Fold bag so the finished bag is in thirds. Place in plastic zipper bag and seal.
11. Hold under ambient condition until OLEAN® solidifies.

### Consumer Preparation:

1. Remove overwrap. Place bag, unfolded, in center of microwave oven.
2. Set microwave on High, and set oven timer for 1¼ to 3 minutes (the actual cooking time will be between pops). Turn microwave oven off. Do not leave microwave oven unattended as overcooking may result in scorching.

TABLE 5
APPLE TURNOVER
Serving Size = 125 gm

| Component/Ingredient | Wt. (gm) | % in Formula |
|---|---|---|
| Pie Dough | 64.00 | 51.20% |
| Apples, slices, IQF (Individually Quick | 30.00 | 24.00% |
| Frozen) | | |
| Apple Pie Sauce | 30.00 | 24.00% |
| Cinnamon Sugar | 1.00 | 0.80% |
| TOTALS | 125 | 100.00% |

Pastry Dough

| | | |
|---|---|---|
| All Purpose Flour, bleached | 35.87 | 56.04% |
| Water, ice | 13.43 | 20.99% |
| OLESTRA ™ - OLEAN ® BAKELEAN ™ | 11.68 | 18.25% |
| 75P | | |
| Sugar, granulated | 1.75 | 2.74% |
| Salt | 0.70 | 1.10% |
| Natural Butter Flavor | 0.29 | 0.46% |
| Nonfat Dry Milk | 0.27 | 0.42% |
| TOTALS | 64.00 | 100.00% |

Apple Pie Filling

| | | |
|---|---|---|
| Water | 20.21 | 67.36% |
| Sugar | 5.91 | 19.69% |
| Sucralose Blend | 2.18 | 7.25% |
| Modified Food Starch | 1.25 | 4.15% |
| Lemon Juice, single strength | 0.31 | 1.04% |
| Salt | 0.09 | 0.31% |
| Cinnamon, ground | 0.06 | 0.21% |
| TOTALS | 0 | 100.00% |

Cinnamon Sugar

| | | |
|---|---|---|
| Sugar | 0.99 | 99.00% |
| Cinnamon, ground | 0.01 | 1.00% |
| TOTALS | 1.00 | 100.00% |

### Dough Preparation:

1. Pre-blend flour, sugar, salt and flavor.
2. Add dry pre-blend to a food processor. Add OLESTRA™. Pulse until crumbly.
3. Add ice water evenly over flour/OLESTRA™ mixture.
4. Pulse until dough is combined but still crumbly.
5. Form into balls, flatten, wrap in plastic and refrigerate for at least 30 minutes.

### Filling Preparation:

1. Pre-blend dry ingredients.
2. Combine pre-blend with remaining ingredients.

### 3. Bring to 190° F. Hold for 1 min.

### 4. Chill.

### Sugar/Cinnamon Preparation:

Blend ingredients.

### Turnover Preparation:

1. Roll dough to ⅛″ thickness using a suitable dough laminator.
2. Cut dough into 5½″ round.
3. Deposit apple pie filling on bottom crust.
4. Crimp crust on top and make slits for vent holes. Sprinkle with cinnamon sugar.
5. Bake for 20 minutes at 350° F. (low fan) until golden brown.

### Consumer Preparation:

1. Microwave on high for 1¼ to 1½ minutes.
2. Let sit 1 minute before serving.
Alternatively can be baked in a 350° F. oven for 15-20 minutes or until hot.

TABLE 6
OLESTRA ™ Based Food Items

| | | g | % daily value | | | | | | % |
|---|---|---|---|---|---|---|---|---|---|
| | | Calories | Total | | | | g | g | OLESTRA ™ |
| | Calories | from fat | Fat | Cholesterol | Sodium | Carbs | Protein | OLESTRA ™ | (of total wt) |
| ENTREES | | | | | | | | | |
| General Tso's Chicken | 260 | 20 | 4 | 20 | 33 | 10 | 27 | 21.5 | 8.5 |
| SAUCES & | | | | | | | | | |
| DRESSINGS | | | | | | | | | |
| Creamy Balsamic | 60 | 50 | 6 | 0 | 260 | 3 | 0 | 5.7 | 19 |
| Vinaigrette Dressing | | | | | | | | | |
| SNACKS | | | | | | | | | |
| Microwave popcorn | 100 | 10 | 2 | 0 | 25 | 7 | 3 | 2.88 | 9.6 |
| DESSERTS | | | | | | | | | |
| Apple Turnover | 200 | 25 | 5 | 0 | 13 | 14 | 4 | 11.68 | 9.2 |

TABLE 7
Comparison of the Food Products With Full Calorie Foods

| | Food Product and | | | |
|---|---|---|---|---|
| | Comparable | Serving | | Total |
| | Full Calorie Food | size g | calories | Fat g |
| Food Product | General Tso's Chicken | 274 | 260 | 2.5 |
| Full Calorie | PF CHANG'S ® General | 485 | 923 | 37 |
| Food | Tso's Chicken | | | |
| | Δ | −211 | −663 | −34.5 |
| | Δ @ equal serving size | | −261 | |
| | SAUCES & DRESSINGS | | | |
| Food Product | Creamy Balsamic | 30 | 60 | 6 |
| | Vinaigrette Dressing | | | |
| Full Calorie Food | KRAFT ® Balsamic | 42.5 | 120 | 11 |
| | Vinaigrette Dressing | | | |
| | Δ | −12.5 | −60 | −5 |
| | Δ @ equal serving size | | −25 | |
| | SNACKS | | | |
| Food Product | Microwave popcorn | 30 | 100 | 1 |
| Full Calorie Food | POP SECRET ® | 28 | 100 | 9 |
| | Microwave popcorn | | | |
| | Δ | +2 | 0 | −8 |
| | Δ @ equal serving size | | −7 | |
| | DESSERTS | | | |
| Food Product | Apple Turnover | 126 | 200 | 3 |
| Full Calorie Food | MCDONALD'S ® | 77 | 250 | 13 |
| | Apple Pie | | | |
| | Δ | +49 | −50 | −10 |
| | Δ @ equal serving size | | −209 | |

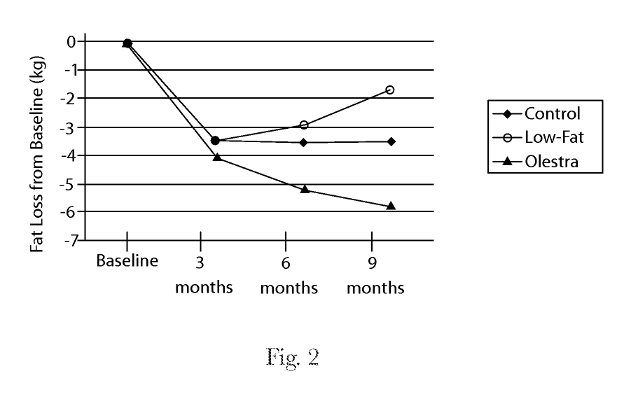

FIG. 2 is a graph which shows body fat loss over time for several diet programs. In the study represented by the graph, overweight men are placed into three groups for a nine month study. The first group is a control group that consumes a diet with 33% fat, a typical American diet. The second group is placed on a reduced fat diet with 25% fat. The third group is placed on a diet with fat substituted with OLESTRA™ replacing one-third of dietary fat. The study that led to the results shown in FIG. 2 is further described in J. C. Lovejoy, et al., Consumption of a controlled low-fat diet containing OLESTRA™ for 9 months improves health risk factors in conjunction with weight loss in obese men: the Ole' Study, International Journal of Obesity (2003) 27, 1242-1249, and G. A. Bray, et al., A 9-mo randomized clinical trial comparing fat-substituted and fat-reduced diets in healthy obese men: the Ole Study, Am J Clin Nutr 2002; 76:928-34. The diet with fat substituted with OLESTRA™ differs from the method described herein in several respects, but shows the weight loss and weight loss maintenance potential of a diet containing OLESTRA™.

As shown in FIG. 2, when overweight men consume OLESTRA™ as part of a varied diet over nine months, weight loss continues for the duration of the study, whereas individuals receiving a typical low calorie or hypocaloric diet regained most of the initial weight lost. Without wishing to be bound by any particular theory, it is believed that subjects on a reduced fat diet will consume a greater amount of non-study foods during the study due to their diet being less palatable than the control diet or the OLESTRA™ diet. The OLESTRA™ diet also has a statistically significant diet effect on cholesterol, LDL and triglycerides, which decreases in fat-substituted diet (OLESTRA™) but not in the other groups at 9 months.

### TEST METHODS

It may be desirable for the food items described herein to be rated equal to in taste and/or satiety, or consumer preferred in taste and/or satiety relative to comparable diet food items. In other words, the food items may be at least consumer-equivalent to comparable diet food items. The food items may, for instance, be equivalent in taste relative to comparable diet food items, but may have greater satiety due to increased portion size (substantially the same number of total calories, but greater weight), aesthetics (e.g., appearance or mouth feel) and/or inclusion of other satiating components. It may also be desirable for the food items to be similar to traditional recipe food items (that is, be found to have a taste that compares favorably to comparable traditional recipe food items).

The food items used for basis of comparison are commercially available foods, which term includes frozen, shelf-stable, and canned foods. The term “comparable” when used in reference to diet or traditional recipe food items, refers to evaluation of the test product relative to the same dish or menu item as both are usually served. Thus, one would compare one General Tso's chicken dish to another, one apple turnover to another, when both are heated for serving, etc. The taste of the food products can be evaluated by providing the panelists with the food products and having them complete a survey that compares the food items to comparable dishes of the diet food items (e.g., STOUFFER'S® LEAN CUISINE®), or traditional recipe food items (e.g., non-diet foods, e.g., STOUFFER'S® regular foods), respectively. In some cases, panelists may prefer the taste of diet foods (e.g., STOUFFER'S® LEAN CUISINE®) to the full calorie versions of the same (e.g., STOUFFER'S® regular foods). In such cases, if it is desired to determine whether the food products are similar to traditional recipe food items, the taste of the food products can be compared to the comparable diet food item. The taste of the foods can be evaluated by asking the following question:

What is your overall opinion of this product? The person evaluating the product can be offered the following choices for expressing their overall opinion about the product: Like it extremely (+4); Like it very much (+3); Like it moderately (+2); Like it slightly (+1); Neither like nor dislike it (0); Dislike it slightly (−1); Dislike it moderately (−2); Dislike it very much (−3); and Dislike it extremely (−4).

Some or all of the questions can be presented in a live verbal interview in person or by telephone, or by survey either: written, computer presented and inputted (for example, over the internet), or by mobile/personal electronic device interaction.

A food item is at least consumer-equivalent relative to a comparable diet food item if the score of the food item is no more than 0.4 points lower than the diet food item when tested among at least 30 panelists. A food item is similar to a comparable traditional recipe food item if the mean difference in score between the food item and the traditional recipe food item is less than 0.5 points lower than the traditional recipe food item when tested among at least 30 panelists. Of course, in the case of either definition, the score of the food item can be higher than that of the comparable food item. The food item may even be preferred to the traditional recipe food item if the mean score for the food item is 0.5 points or more than the score of the traditional recipe food item when tested among at least 30 panelists.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 grams” is intended to mean “about 40 grams”.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of dietary management of a diet-responsive disease or condition, said method comprising:
(a) providing at least one at least consumer-equivalent food product for the dietary management of a diet-responsive disease or condition, said food product being in a prepackaged form and selected from the group consisting of a frozen or shelf stable: complete meal, main course of a meal, appetizer, entree, side dish for a meal, sauce, dressing, dessert, snack, cooked food, hot food, microwavable food, cooking oil, and a spread, wherein said food product is prepared using a recipe which has been modified to replace at least some digestible fat in the recipe with a fat replacement ingredient, said food product is packaged for storage and distribution, and is suitable for consumption five or more days after being packaged;
(b) directly or indirectly providing a consumer with a plan for consuming said at least one food product; and
(c) allowing a consumer to purchase said at least one food product after a medical professional provides approval for said at least one food product for said consumer, wherein when said consumer ingests a quantity of said food product over a period of time, said consumer changes from having a first state of a diet-responsive condition to a second state wherein said diet-responsive condition is improved in said second state relative to said first state.

2. The method of claim 1 wherein said diet-responsive condition is selected from the group consisting of atherosclerotic disease, cardiovascular disease, coronary heart disease, diabetes, dyslipidemia, hypercholesterolemia, hypertension, metabolic syndrome, obesity, osteoarthritis, overweight, pre-diabetes, satiety, sleep apnea, or to reduce risk factors for one or more of: breast, endometrium, colon, kidney, and esophageal cancers.

3. The method of claim 1 further comprising a step of informing at least one medical professional of the availability of said at least one food product and of the medical professional's ability to supervise and/or to write an order for said at least one food product.

4. The method of claim 1 comprising a partially digestible or non-digestible fat replacement ingredient.

5. The method of claim 4 wherein said partially digestible or non-digestible fat replacement ingredient comprises an edible, substantially non-absorbable, substantially non-digestible polyol fatty acid polyester having at least 4 fatty acid ester groups, wherein said polyol is selected from the group consisting of sugars and sugar alcohols containing from 4 to 8 hydroxy groups and wherein each fatty acid group has from 2 to 24 carbon atoms.

6. The method of claim 4 wherein said partially digestible or non-digestible fat replacement ingredient comprises a sucrose polyester.

7. The method of claim 4 wherein said partially digestible or non-digestible fat replacement ingredient comprises a mixture of octa-, hepta-, and hexa-esters of sucrose with fatty acids derived from edible fats and oils or fatty acids, wherein the chain lengths of the fatty acids contain no less than 12 carbon atoms.

8. A method of controlling caloric intake and/or amount of calories burned by a human consumer, said method comprising:
(a) providing a consumer with a program or plan for: (i) reducing their average daily caloric intake over a period of time by greater than or equal to about 50 calories; and (ii) increasing their physical activity to use an additional 50 or more calories per day;
(b) providing to said consumer a plurality of prepackaged foods, each of said foods comprising an at least consumer-equivalent, reduced fat food product for the dietary management of a diet-responsive disease or condition, said food product comprising a fat replacement ingredient, wherein said food product is packaged for storage and distribution, and is suitable for consumption five or more days after being packaged; and
(c) wherein when said consumer ingests a quantity of said food products over a period of time, said consumer changes from having a first state of a diet-responsive condition to a second state wherein said diet-responsive condition in said second state is improved relative to said first state.

9. The method of claim 8 wherein step (a) comprises providing the consumer with diet and/or activity guidance in the form of one or more tips.

10. The method of claim 8 wherein said prepackaged food products are selected from the group consisting of a frozen or shelf stable: complete meals, main courses of a meal, appetizers, entrees, side dishes for a meal, sauces, dressings, desserts, snacks, cooked foods, hot foods, microwavable foods, cooking oils, and spreads.

11. A method according to claim 8 wherein said fat replacement ingredient comprises a partially digestible or non-digestible fat.

12. A method according to claim 11 wherein said partially digestible or non-digestible fat comprises an edible, substantially non-absorbable, substantially non-digestible polyol fatty acid polyester having at least 4 fatty acid ester groups, wherein said polyol is selected from the group consisting of sugars and sugar alcohols containing from 4 to 8 hydroxy groups and wherein each fatty acid group has from 2 to 24 carbon atoms.

13. A method according to claim 11 wherein said partially digestible or non-digestible fat comprises a sucrose polyester.

14. A method according to claim 11 wherein said partially digestible or non-digestible fat comprises a mixture of octa-, hepta-, and hexa-esters of sucrose with fatty acids derived from edible fats and oils or fatty acids, wherein the chain lengths of the fatty acids contain no less than 12 carbon atoms.

15. The method of claim 8 wherein the period of time is at least 6 months.
